(19) United States
(12) Patent Application Publication
(10) Pub. No.: US 2016/0368299 A1
(43) Pub. Date: Dec. 22, 2016

(54) IMAGE ERASING APPARATUS

(71) Applicants: KABUSHIKI KAISHA TOSHIBA, Tokyo (JP); TOSHIBA TEC KABUSHIKI KAISHA, Tokyo (JP)

(72) Inventor: Yuuichi Akiyama, Numazu (JP)

(21) Appl. No.: 15/185,321

(22) Filed: Jun. 17, 2016

(30) Foreign Application Priority Data
Jun. 22, 2015 (JP) 2015-125155

(51) Int. Cl. B41M 7/00

(52) U.S. Cl. CPC B41M 7/0009

(57) ABSTRACT

An image erasing apparatus comprises an erasing section which erases an image; a reading section which reads a sheet; a first storage which stores a temperature when the erasing section is heated; a second storage which stores a reference for determining whether or not a recording material of the sheet is decolored; and a controller which controls the erasing section to raise the temperature to the target temperature stored in the first storage to erase the image formed on sheet, reads the erased image on the sheet with the reading section and controls the heating source of the erasing section to heat the erasing section at a temperature above the target temperature stored in the first storage if it is determined that the recording material of the sheet is not decolored by comparing the reference stored in the second storage and the image read by the reading section.

### CROSS-REFERENCE TO RELATED APPLICATION

This application is based upon and claims the benefit of priority from Japanese Patent Application No. 2015-125155, filed Jun. 22, 2015, the entire contents of which are incorporated herein by reference.

### FIELD

Embodiments described herein relate generally to an image erasing apparatus for erasing an image printed on a sheet.

### BACKGROUND

As one type of an image forming apparatus, an image forming apparatus equipped with a so-called decoloring apparatus is known which prints an image on a sheet with the use of a recording material, for example, a decolorable toner, executes a decoloring processing on the toner for forming the image through heating and erasing the image formed on the sheet. The decoloring apparatus comprises a reading section that reads the image in order to store the image before the image is erased and a decoloring section that decolors toner for forming the image, and is known to read the image again with the foregoing reading section to determine whether or not the decoloring processing is normally executed after the decoloring processing.

Furthermore, at the time the image formed on the sheet is erased, a series of operations is executed, including an operation of reading and storing content of the sheet with the reading section and an operation of decoloring the content of the sheet. At the time the image formed with the decolorable recording material on the sheet is erased, the decoloring apparatus applies heat to the decolorable recording material to decolor the recording material with a heater constituting the decoloring section. However, in such a decoloring apparatus, the decolorable recording material must be heated to a temperature equal to or greater than a decoloring temperature.

On the other hand, the different types of decolorable recording materials are continuously increasing in an office, such as a ball point pen using decolorable ink as the recording material or the image forming apparatus equipped with the foregoing decolorable toner. Thus, in accordance with the environment of the office where the image erasing apparatus is employed, it is necessary to properly set a heating temperature of the decoloring section of the image decoloring apparatus in accordance with the used recording material.

### DESCRIPTION OF THE DRAWINGS

FIG. 1 is a schematic cross-sectional view of an image erasing apparatus according to an embodiment;

FIG. 2 is a block diagram of the image erasing apparatus according to the present embodiment;

FIG. 3 is a diagram illustrating a first storage area according to the present embodiment;

FIG. 4 is a diagram illustrating a third storage area according to the present embodiment;

FIG. 5 is a flowchart illustrating a process of a setting job of the image erasing apparatus according to the present embodiment; and

FIG. 6 is a diagram illustrating a third storage area according to another embodiment.

### DETAILED DESCRIPTION

In accordance with an embodiment, an image erasing apparatus comprises an erasing section configured to include a heating source and erase an image formed on a sheet with a recording material decolored by heat through heating; a reading section configured to be arranged at the downstream side of the erasing section in a conveyance direction of the sheet and read the sheet; a first storage configured to store a target temperature at the time of heating the erasing section; a second storage configured to store a reference for determining whether or not the recording material of the sheet is decolored; and a controller configured to control the erasing section to raise the temperature to the target temperature stored in the first storage to erase the image formed on sheet, read the erased image on the sheet with the reading section and control the heating source of the erasing section to heat the erasing section at a temperature higher than the target temperature stored in the first storage section if it is determined that the recording material of the sheet is not decolored by comparing the reference stored in the second storage and the image read by the reading section.

Hereinafter, the embodiment of the present invention is described with reference to the accompanying drawings.

### Present Embodiment

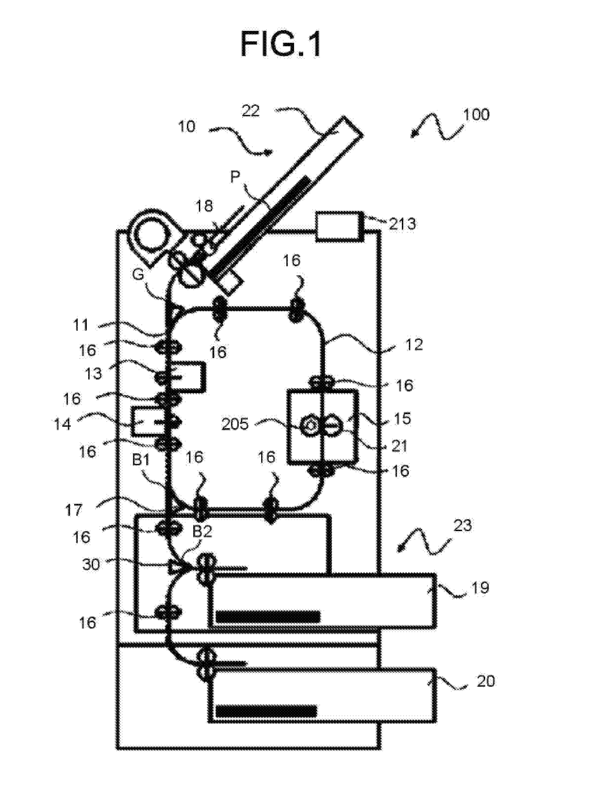

FIG. 1 is a schematic cross-sectional view of an image erasing apparatus 100 according to the present embodiment. The image erasing apparatus 100 erases an image of a sheet P serving as an image receiving medium on which the image is formed already and can reuse the sheet P. Further, in the present embodiment, erasing processing of decoloring a recording material through heating to erase an image is described as an example of erasing processing.

The image erasing apparatus 100 of the present embodiment executes decoloring processing for decoloring the color of the image through the heating at a temperature equal to or higher than a predetermined temperature (hereinafter, referred to as a decoloring temperature or a target temperature) to the sheet P on which the image is formed with decolorable toner or decolorable ink serving as the recording material. The decolorable recording material contains a color generation compound, a developer, and a decoloring agent. As the color generation compound, for example, a leuco dye is exemplified. As the developer, for example, phenols are exemplified. As the decoloring agent, a substance which is blended with the color generation compound if heated and does not have affinity to the developer is exemplified. The decolorable recording material develops the color through interaction of the color generation compound and the developer, and can be decolored as the interaction of the color generation compound and the developer is cut off or prevented through the heating at the temperature equal to or higher than the decoloring temperature.

The image erasing apparatus 100 shown in FIG. 1 includes a sheet feed section 10 for housing the sheet P, a first conveyance path 11 and a second conveyance path 12 for conveying the sheet P, a first reading section 13 and a second reading section 14 for reading the image of the sheet P, an erasing section 15 for discoloring the recording material used to form the image of the sheet P, conveyance rollers 16 arranged in each conveyance path, a first route change section 17 for switching a conveyance route of the sheet P, a sheet discharge section 23 for housing the sheet P to which a processing is completed and a second route change section 30 arranged in the first conveyance path 11 for switching a route to sheet discharge section 23 of the sheet P. Further, the first conveyance path 11 and the second conveyance path 12 and the conveyance rollers 16 are equivalent to a conveyance section.

The sheet feed section 10 houses the sheet P to be reused on which the image is already formed. Then, in order to erase the image of the sheet P, the sheet P is fed to the inside of the image erasing apparatus 100. The sheet P to be reused is a sheet P on which an image is formed with the decolorable toner serving as the recording material through the heating. Further, the sheet P may have various sizes such as A3, A4, B5, Letter, Legal, and the like. The sheet feed section 10 includes a sheet feed tray 22 and a pickup roller 18 (hereinafter, referred to as a sheet feed tray pickup roller) for picking up the sheet P in the sheet feed tray 22. The sheet feed tray 22 stacks the sheet P to which the erasure of the image is carried out. The sheet feed tray pickup roller 18 picks up the sheets P one by one from the sheet feed tray 22 to send out the sheets P to the first conveyance path 11 in order. Further, a sheet feed section sensor (not shown), arranged in the sheet feed section 10, is used to detect whether or not the sheet P exists in the sheet feed tray 22. The sheet feed section sensor is, for example, an infra-red sensor. Alternatively, a sensor using a well-known micro switch can also be used. The sheet feed section sensor sends a detection result to a control section described later.

The first conveyance path 11 and the second conveyance path 12 include a plurality of conveyance rollers 16. Each conveyance roller 16 is composed of a pair of a driving roller and a driven roller.

The first reading section 13 and the second reading section 14 are arranged in the first conveyance path 11 along the conveyance path. The first conveyance path 11 conveys the sheet P from the sheet feed section 10 to the sheet discharge section 23 through the conveyance roller 16 via the first reading section 13 and the second reading section 14.

In the present embodiment, as the sheet P is conveyed from the sheet feed section 10 to the sheet discharge section 23, the sheet feed section 10 side is regarded as the upstream side with respect to the conveyance direction of the sheet P, and the sheet discharge section 23 side is regarded as the downstream side with respect to the conveyance direction of the sheet P.

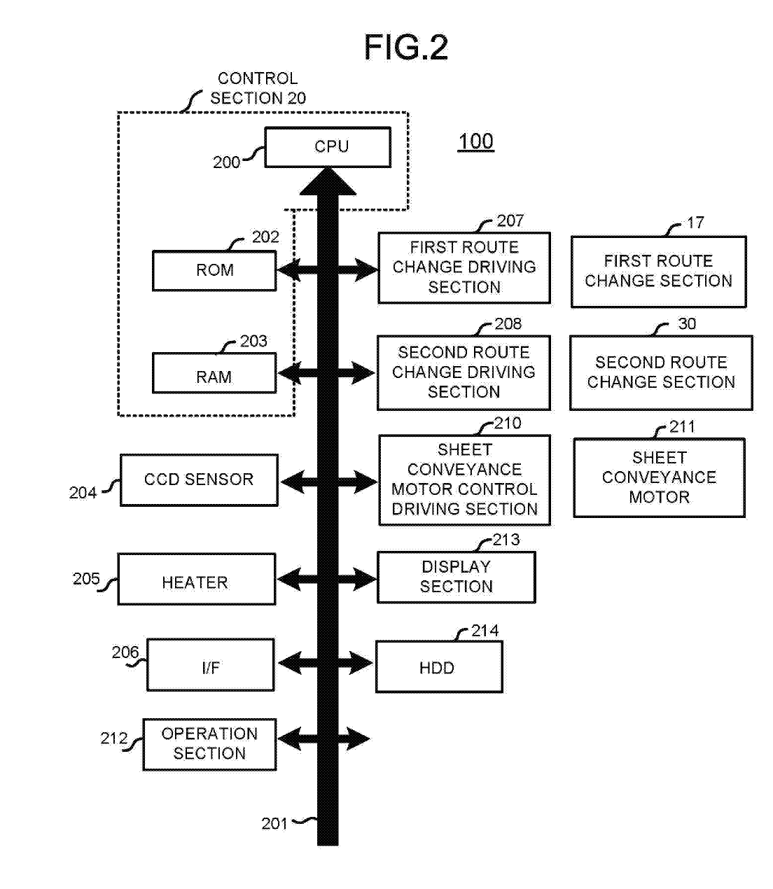

The first reading section 13 and the second reading section 14 each include, for example, a two-dimensional CCD scanner (the combination of the first reading section 13 and the second reading section 14 is equivalent to a reading section). The two reading sections 13 and 14, for example, are arranged at mutually different positions across the first conveyance path 11. According to such a configuration, the first reading section 13 reads one side of the conveyed sheet P, and the second reading section 14 reads the other side opposite to the side read by the first reading section 13. The images read by the first reading section 13 and the second reading section 14, for example, are properly stored in a later-mentioned HDD 214 shown in FIG. 2.

The first conveyance path 11 is connected to the sheet discharge section 23 via a branch point B1 positioned at the downstream side of the first reading section 13 and the second reading section 14 in the conveyance direction of the sheet P. As shown in FIG. 1, the second conveyance path 12 is connected with the branch point B1, and the first route change section 17 for switching the routes between the first conveyance path 11 and the second conveyance path 12 is arranged at the branch point B1. For example, it is set by default that the first route change section 17 allows the route for conveying the sheet P from the sheet feed section 10 to the sheet discharge section 23 via the first reading section 13 and the second reading section 14.

The second conveyance path 12 is branched from the conveyance path 11 at the branch point B1 and merged with the first conveyance path 11 at a merging point G positioned at the upstream side of the first reading section 13 and the second reading section 14 in the first conveyance path 11 and at the downstream side of the sheet feed section 10.

The erasing section 15 is arranged in the second conveyance path between the branch point B1 and the merging point G of the first conveyance path 11 and the second conveyance path 12. The erasing section 15 includes a roller pair 21 and a heater 205 serving as the heating source. The heater 205, for example, is arranged in at least one of rollers constituting the roller pair 21. The roller pair 21 is heated by the heater 205. In this way, in the erasing section 15, through the heater 205, the image of the sheet P formed with the decolorable toner is heated to the decoloring temperature (target temperature) via the roller and the toner for forming the image is decolored. Further, though not shown, a temperature sensor is arranged in the vicinity of the roller pair 21. The temperature sensor measures the temperature of the roller pair 21 and sends a measured result to the control section described later.

The sheet discharge section 23 stores the sheet P of which the image is erased by the erasing section 15. The sheet discharge section 23, for example, includes the first sheet discharge section 19 and the second sheet discharge section 20. In order to selectively convey the sheet P via the reading sections 13 and 14 to the first sheet discharge section 19 or the second sheet discharge section 20, the second route change section 30 is arranged at a branch point B2 at the downstream side of the first route change section 17 in the first conveyance path 11. The second route change section 30 switches the route of the sheet P conveyed via the first route change section 17 to the first sheet discharge section 19 or the second sheet discharge section 20. Through the switching of the route by the second route change section 30, the sheet P is conveyed to the first sheet discharge section 19 or the second sheet discharge section 20. It is set by default that the second route change section 30 allows the route conveying the sheet P to the first sheet discharge section 19. Further, the reusable sheet P is placed in the first sheet discharge section 19 and the non-reusable sheet P is placed in the second sheet discharge section 20.

FIG. 2 is a block diagram of the image erasing apparatus 100. A CPU (Central Processing Unit) serving as the controller (hereinafter, referred to as a controller 200) of the image erasing apparatus 100, via a system bus line 201, is connected with a ROM (Read Only Memory) 202, a RAM (Random Access Memory) 203, CCD sensors 204 of the reading sections 13 and 14, the heater 205 of the erasing section 15, an interface (I/F) 206 for carrying out data input and output with an external device such as a client terminal, a first route change driving section 207 for controlling the first route change section 17, a second route change driving section 208 for controlling the second route change section 30, a sheet P conveyance motor 211 for driving various rollers, a sheet P conveyance motor control driving section 210 for controlling the sheet P conveyance motor 211, an operation section 212 for carrying out the input of various setting, a display section 213 and the HDD 214. The ROM 202, the RAM 203 and the CPU constitute the controller 200.

The ROM 202 stores a program or a threshold value for enabling the CPU of the controller 200 to operate.

In the RAM 203, various memory areas such as a work area serving as a job area of a data processing by the CPU of the controller 200 are dynamically formed. Further, in the present embodiment, the RAM 203 includes a mode management flag storage area. The mode management flag storage area stores a flag for managing a mode in which the image erasing apparatus 100 operates. In a case in which an erasure mode is selected by the operation section 212, the mode management flag storage area stores “1”. In a case in which a setting mode for setting the heating target temperature of the heater 205 of the erasing section 15 for discoloring the toner on the sheet P is selected, the mode management flag storage area stores “0”.

The CCD sensors 204 constituting the reading sections 13 and 14 are arranged as a row of line sensors (two-dimensional scanner) for reading the image of the sheet P and detect light and shade of the surface of the sheet P with the conveyance of the sheet P. The CCD sensor 204 detects the light and shade of the surface of the sheet P to read out or detect the image. The reading section is not limited to the CCD sensor and may alternatively be a CMOS sensor.

The heater 205 of the erasing section 15 uses, for example, an induction heating (IH) heater. As stated above, while the erasing section 15 passes through the sheet P, via the roller pair 21, the heat from the heater 205 is indirectly applied to the sheet P and the toner forming the image is discolored. The heater 205 may be optional as long as the image erasing apparatus 100 is capable of controlling the temperature of the sheet P. In addition to the induction heating heater, for example, a lamp heater such as a halogen lamp may be used.

The operation section 212 is an input section that includes various setting and instruction keys and inputs various operations. The display section 213 displays various processing modes of the image erasing apparatus 100. The display section 213 may also be a known touch panel type to function as the operation section 212. In a case of carrying out the erasure of the image, an operator operates the key of the operation section 212, for example, the operator presses a selection key (not shown) arranged on the operation section 212 to select the erasure mode in advance. In the erasure mode, the sheet P is conveyed to the erasing section 15 after all the images of the sheet P are read by the first reading section 13 and the second reading section 14. Then, after the images of the sheet P are erased by the erasing section 15, the sheet P is discharged to the sheet discharge section 23. Further, in the erasure mode, in a case in which the operator selects the setting mode for setting the target temperature at the time of heating the heater 205, similarly, the operator operates the key of the operation section 212. Furthermore, the operation section 212 includes a start key (not shown) for staring the processing of each mode.

The controller 200 controls the first route change driving section 207 to drive the first route change section 17 to switch the default position to executes distribution so that the sheet P is conveyed from the first conveyance path 11 to the second conveyance path 12.

Further, the control section 200 controls the second route change driving section 208 to drive the second route change section 30 to distribute the sheet P to the first sheet discharge section 19 or the second sheet discharge section 20.

The HDD 214 includes a first storage area (first storage), a second storage area (second storage), a third storage area (third storage) and a first image storage area for storing the erased image of the sheet P.

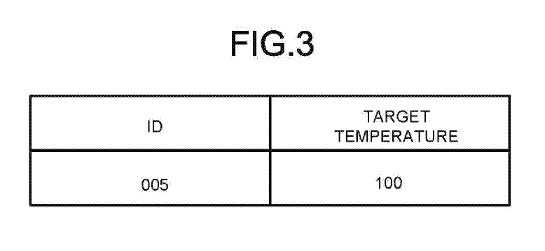

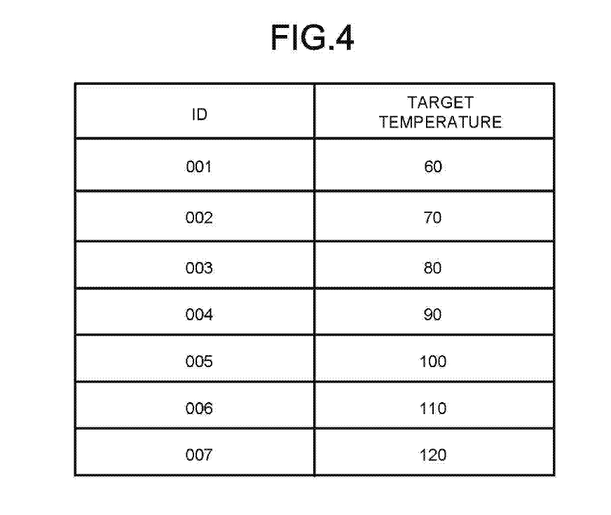

The first storage area stores the target temperature for heating the heater 205. The heater 205 can be heated to the temperature (target temperature) stored in the first storage area. The first storage area is composed of an ID area and a target temperature area corresponding to the ID area as shown in FIG. 3. The content stored in the first storage area is one ID and one target temperature corresponding to the ID. The ID refers to an identifier assigned to each target temperature for managing the target temperature. The second storage area stores a reference value for determining whether or not the toner on the sheet P heated by the erasing section 15 is correctly decolored. Specifically, the second storage area stores a threshold value of the printing rate of the image of the sheet P and a threshold value of the density of the image of the sheet P. The controller determines whether or not the decoloring processing is normally executed on the basis of the two threshold values. The third storage area includes an ID area for storing an ID and a target temperature area for storing a target temperature of the heater 205 corresponding to the ID as shown in FIG. 4. A plurality of the IDs and a plurality of the target temperatures are stored correspondingly. The setting mode sets the temperatures stored in the third storage area in the first storage area as the target temperatures of the heater 205 in the ascending order and refers to the target temperatures at the time of discoloring the toner on the sheet P (further, the value stored in the target temperature area of the third storage area is equivalent to information for setting the target temperature higher than the temperature stored in the first storage).

Further, the erasure mode refers to a mode of erasing the image of the sheet P at one target temperature. In other words, on the basis of the temperature set in the first storage area, the image formed on the sheet P is erased. The setting mode refers to a mode of selecting one proper temperature from the target temperatures stored in the third storage area and setting the proper temperature in the first storage area.

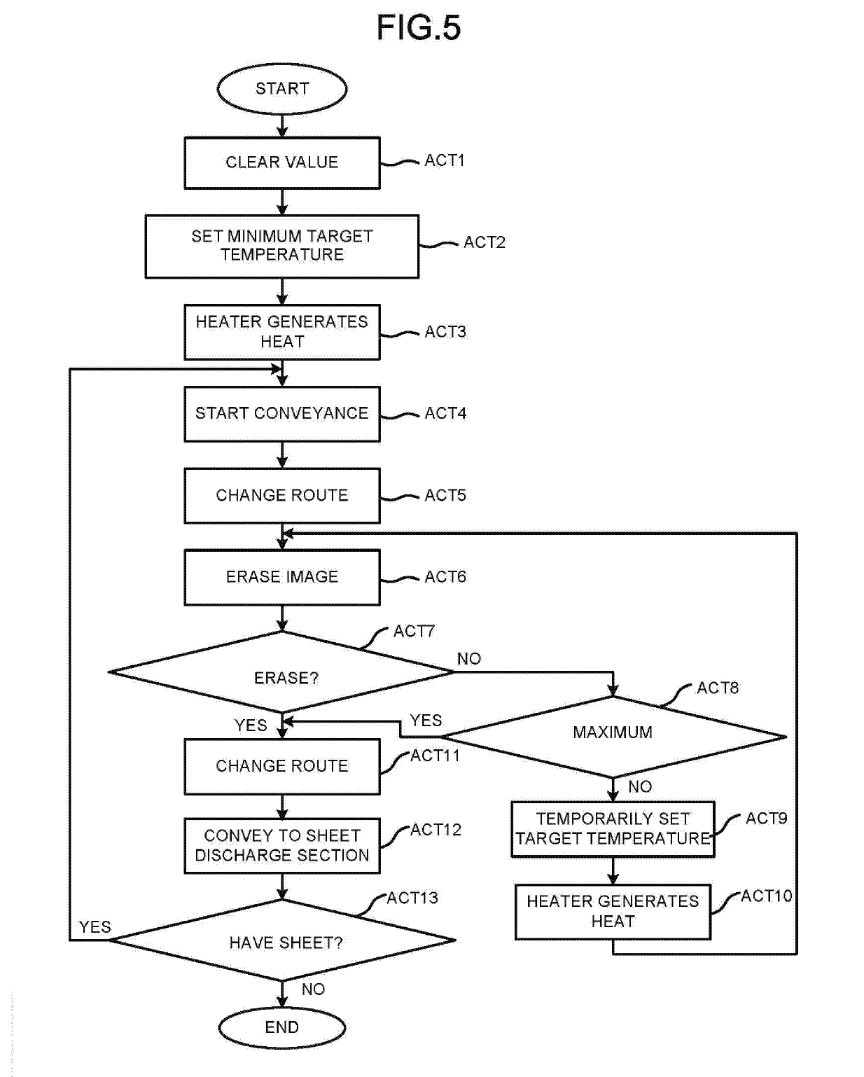

In the image erasing apparatus 100 with the foregoing configuration, the controller 200 executes, for example, the setting job shown in FIG. 5 on the basis of the preset program. In the following description, the operator operates the operation section 212 to select the setting mode and press the start key. The sheet P of which the image is erased is already set in the sheet feed tray 22. The sheet P set in the sheet feed tray 22 may be a sheet P printed in the office or a sheet P carried by the operator (serviceman) on which an image is formed with the decolorable recording material for preset.

First, the controller 200 clears the value in the first storage area of the HDD 214 (ACT 1). Sequentially, the controller 200 reads out the lowest target temperature from the third storage area of the HDD 214. Specifically, the controller 200 retrieves the ID of which the value is minimum from the ID area of the third storage area. Then, the controller 200 stores the target temperature corresponding to the ID of which the value is minimum in the first storage area of the HDD 214 (ACT 2). Then, the controller enables the heater 205 of the erasing section 15 to generate the heat to raise the temperature to the target temperature (ACT 3).

Next, the controller 200 starts the conveyance of the sheet P set in the sheet feed tray 22 (ACT 4). Specifically, the controller 200 picks up one sheet P set in the sheet feed tray 22 with the use of the sheet feed tray pickup roller 18. Then, the controller 200 controls the sheet P conveyance motor control driving section 210 to activate the sheet P conveyance motor 211 to drive the conveyance roller 16 to convey the sheet P in the first conveyance path 11.

The first route change section 17 allows the default position of the route for conveying the sheet P from the sheet feed section 10 to the sheet discharge section 23. Thus, the controller 200 controls the first route change driving section 207 to drive the first route change section 17 to switch the route to be capable of conveying the sheet P to the second conveyance path 12 via the branch point B1. In this way, the conveyance path from the second reading section 14 to the erasing section 15 is connected (ACT 5).

After the first conveyance path 11 and the second conveyance path 12 are connected, the controller 200 conveys the sheet P to the erasing section 15 via the branch point B1 of the first conveyance path 11 and the second conveyance path 12. The sheet P conveyed to the erasing section 15 is sandwiched and conveyed by the roller pair 21 heated by the heater 205. The image (toner) formed on the conveyed sheet P is heated by the erasing section 15. Then, the temperature of the toner formed on the sheet P rises to the temperature set in the processing in ACT 2 and the toner is decolored (ACT 6).

Furthermore, the controller 200 reconveys the sheet P to the first conveyance path 11 via the merging point G of the first conveyance path 11 and the second conveyance path 12 located at the upstream side of the first reading section 13 and the second reading section 14. The controller 200 controls the first reading section 13 and the second reading section 14 arranged in the first conveyance path 11 to read the surfaces of the sheet P of which the image is erased. The read image is stored in the first image storage area of the HDD 214. Then, it is determined whether or not the erasure of the image formed on the paper P is carried out by comparing the image stored in the first image storage area of the HDD 214 with the reference value stored in the second storage area (ACT 7).

If it is determined that the image formed on the sheet P is not erased (No in ACT 7), the controller 200 determines whether or not the ID stored in the ID area of the first storage area of the HDD 214 is the maximum ID stored in the ID area of the third storage area of the HDD 214 (ACT 8). In other words, it is determined whether or not the highest target temperature stored in the third storage area of the HDD 214 is stored in the first storage area. If it is determined that the maximum ID is not stored in the first storage area (No in ACT 8), the controller 200 retrieves the second maximum value of the IDs stored in the ID area of the first storage area of the HDD 214 from the ID area of the third storage area of the HDD 214 HDD 214. Then, the controller 200 stores the target temperature corresponding to the second maximum ID in the first storage area of the HDD 214 in an overwrite manner (ACT 9). Then, the controller 200 heats the heater 205 to the newly set target temperature stored in the target temperature area of the first storage area of the HDD 214 (ACT 10).

Then, the controller 200 returns to the processing in ACT 6 to carry out the same processing. In other words, the controller 200 conveys the sheet P to the erasing section 15 via the branch point B1 of the first conveyance path 11 and the second conveyance path 12. The sheet P conveyed to the erasing section 15 is heated to the new target temperature set in the processing in ACT 9 through the heated roller pair 21. In this way, the image (toner) formed on the sheet P is decolored. The process (from ACT 6 to ACT 10) is repeated until it is determined that the image is erased in ACT 7 or it is determined in ACT 8 that the decoloring temperature is the maximum.

Thus, in ACT 8, if it is determined that the maximum ID is stored in the first storage area (Yes in ACT 8), the controller 200 executes the processing in ACT 11. The controller 200 controls the first route change driving section 207 to drive the first route change section 17 to switch the route.

On the other hand, if the controller 200 determines that the image formed on the sheet P is erased (Yes in ACT 7), the controller 200 controls the first route change driving section 207 to drive the first route change section 17 to switch the route to be capable of conveying the sheet P to the first sheet discharge section 19 via the branch point B1. In this way, the conveyance path from the second reading section 14 to the first sheet discharge section 19 is connected. If the conveyance path from the second reading section 14 to the first sheet discharge section 19 of the sheet discharge section 23 is connected, the sheet P is conveyed to the first sheet discharge section 19 (ACT 12). In this way, the reusable sheet P is placed in the first sheet discharge section 19.

On the other hand, if it is determined that the maximum ID is stored in the first storage area (Yes in ACT 8), the controller 200 controls the first route change driving section 207 and the second route change driving section 208 to drive the first route change section 17 and the second route change section 30 to switch the routes to be capable of conveying the sheet P to the second sheet discharge section 20 via the branch points B1 and B2. In this way, the conveyance path from the second reading section 14 to the second sheet discharge section 20 is connected. If the conveyance path from the second reading section 14 to the second sheet discharge section 20 is connected, the sheet P is conveyed to the second sheet discharge section 20 (ACT 12). In this way, the reusable sheet P is placed in the second sheet discharge section 20.

If the sheet P is conveyed to the sheet discharge section 23, the controller 200 determines whether or not there is the sheet P in the sheet feed tray 22 according to the detection result of the sheet feed section sensor (ACT 13). If the controller 200 determines that there is the sheet P in the sheet feed tray 22 (Yes in ACT 13), the controller 200 returns to the processing in ACT 4 to convey the sheet P from the sheet feed tray 22 and decolor the toner of the sheet P again. At this time, the temperature of the heater 205 is already set; however, if it is determined in ACT 7 that the image is not erased, in ACT 9, as stated above, with reference to the ID and the target temperature in the third storage area, the controller 200 changes the target temperature stored in the first storage area to a higher target temperature to decolor the toner on the sheet P to erase the image at the high target temperature. The process from ACT 4 to ACT 13 is repeatedly executed until it is determined that there is no sheet P in the sheet feed tray 22. On the other hand, if the controller 200 determines that there is no sheet P in the sheet feed tray 22 (No in ACT 13), the controller 200 turns off the heater 205 to terminate the setting job. Further, if it is determined that the image is not erased in ACT 7 and it is determined that the decoloring temperature set in ACT 8 is the maximum (Yes in ACT 8), the controller 200 displays a message indicating that the image cannot be erased on the display section 213 and may inform of the user about the massage.

In the image erasing apparatus 100 with the foregoing configuration, it is possible to set a proper erasure temperature in the environment of the office or store where the image erasing apparatus is arranged. For example, two sheets P having different decoloring temperatures are placed in the sheet feed tray 22 of the image erasing apparatus 100, and a case of setting the target temperature through the setting mode is exemplified. It is assumed, for example, that the image of one sheet is formed with the recording material decolored at the temperature of 80 degrees centigrade. It is also assumed, for example, that the images of two sheets are formed with the recording material decolored at the temperature of 110 degrees centigrade. Then, if the operator presses the start key, the setting job is started. In a case of erasing the image formed on the first sheet P and erasing the image formed on the second sheet P, the heater 205 is superheated to carry out the erasure of the image formed on the second sheet P by taking 80 degrees centigrade at which the image formed on the first sheet P is erased as the target temperature but not 60 degrees centigrade serving as the lowest target temperature stored in the third storage area. According to the foregoing processing, the image erasing apparatus 100 used in various environments can set the proper target temperature and can properly erase the image formed on the sheet P.

In the present embodiment, the first storage area, the second storage area and the third storage area are stored in one HDD 214; however, they may be stored in different storages respectively such as a plurality of HDDs, ROM, and the like.

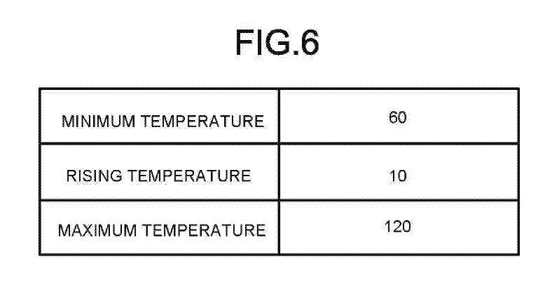

In the present embodiment, a plurality of the target temperatures, in other words, the temperatures supposed to be stored in the first storage area is stored in the third storage area; however, the target temperature stored in the third storage area is not limited to this. For example, the maximum temperature, the minimum temperature and the rising temperature may be stored. More specifically, as shown in FIG. 6, in the setting mode, the minimum temperature set in the first area in ACT 2 shown in FIG. 5 is stored in the first storage section. Further, in ACT 9, a value obtained by adding the rising temperature stored in the third storage area to the temperature stored in the first storage area is read and stored in the first storage area as the new target temperature. Furthermore, in ACT 8, the maximum temperature used for the determination about whether or not the temperature of the erasing section 15 rises to the maximum is also stored in the third storage area as stated above. It is possible to exhibit the effect of the present invention even if the third storage area is described as the above (further, the rising temperature in the third storage area is equivalent to information for setting the higher temperature in the first storage).

According to the foregoing embodiment, in a case in which the decoloring processing is carried out on the sheets P on which the images are printed with the recording materials having the different decoloring temperatures, the decoloring processing can be carried out at the decoloring temperature suitable to the recording material respectively. Further, even if these sheets P are mixed and the decoloring processing is carried out, the decoloring processing can be executed properly.

While certain embodiments are described, these embodiments are presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An image erasing apparatus, comprising:
an erasing section comprising a heating source and configured to erase an image formed on a sheet with a recording material decolored by heat through heating;
a reading section arranged at the downstream side of the erasing section in a conveyance direction of the sheet and read the sheet;
a first storage configured to store a target temperature at the time of heating the erasing section;
a second storage configured to store a reference for determining whether or not the recording material of the sheet is decolored; and
a controller configured to control the erasing section to raise the temperature to the target temperature stored in the first storage to erase the image formed on sheet, read the erased image on the sheet with the reading section and control the heating source of the erasing section to heat the erasing section at a temperature higher than the target temperature stored in the first storage if it is determined that the recording material of the sheet is not decolored by comparing the reference stored in the second storage and the image read by the reading section.

2. The image erasing apparatus according to claim 1, further comprising:
a third storage configured to at least store information for setting the target temperature higher than the temperature stored in the first storage, wherein
if it is determined that the recording material of the sheet is not decolored, the controller newly stores the temperature higher than the target temperature stored in the first storage on the basis of the information stored in the third storage and controls the heating source of the erasing section to heat the erasing section by taking the newly stored high temperature as the target temperature of the erasing section.

3. The image erasing apparatus according to claim 2, further comprising:
a sheet feed section configured to feed the placed sheet to the inside of a housing, wherein
if it is determined that the recording material of the sheet is not decolored, after newly storing the temperature higher than the target temperature stored in the first storage on the basis of the information stored in the third storage, if it is determined that the sheet is placed in the sheet feed section, the controller controls the heating source to heat the erasing section to the target temperature newly stored in the first storage and controls the sheet feed section to carry out the conveyance of the sheet.

4. The image erasing apparatus according to claim 2, further comprising:
a conveyance path configured to include the erasing section arranged at the downstream side of the reading section in the conveyance direction of the sheet and be merged from the downstream side of the erasing section in the conveyance direction of the sheet to the upstream side of the reading section in the conveyance direction of the sheet, wherein
if it is determined that the recording material of the sheet is not decolored, after newly storing the temperature higher than the target temperature stored in the first storage on the basis of the information stored in the third storage, the controller controls the heating source to heat the erasing section to the target temperature newly stored in the first storage and controls the conveyance path to convey the sheet to the erasing section again.

5. The image erasing apparatus according to claim 1, further comprising:
an input section, wherein
in a case in which the switching to a setting mode of setting the target temperature recorded in the first storage is input by the input section, the controller carries out the change of the target temperature in the first storage on the basis of the information stored in the third storage.

6. An image erasing method, comprising:
erasing an image formed on a sheet with a recording material decolored by heat through heating;
storing a target temperature at the time of heating;
storing a reference for determining whether or not the recording material of the sheet is decolored; and
raising the temperature to the target temperature to erase the image formed on sheet, reading the erased image on the sheet and heating at a temperature higher than the target temperature if it is determined that the recording material of the sheet is not decolored by comparing the reference and the image read.

7. The image erasing method according to claim 6, further comprising:
storing information for setting the target temperature higher than a stored temperature, wherein
if it is determined that the recording material of the sheet is not decolored, storing the temperature higher than the target temperature stored and heating by taking the newly stored high temperature as the target temperature.
